(19) United States
(12) Patent Application Publication
(10) Pub. No.: US 2012/0233044 A1
(43) Pub. Date: Sep. 13, 2012

(54) APPARATUSES, METHODS, AND SYSTEMS FOR A LABOR PROJECT MANANGEMENT AND COSTING SYSTEM AND PLATFORM

(76) Inventors: Joseph P. Burger, Lyndhurst, NJ (US); Albert E. Logan, Franklin Lakes, NJ (US); Dean A. Logan, Franklin Lakes, NJ (US); Kevin P. Romano, Franklin Lakes, NJ (US)

(21) Appl. No.: 13/312,662

(22) Filed: Dec. 6, 2011

Related U.S. Application Data
(60) Provisional application No. 61/420,235, filed on Dec. 6, 2010.

(51) Int. Cl. G06Q 10/10

(52) U.S. Cl. 705/32

(57) ABSTRACT

The APPARATUSES, METHODS, AND SYSTEMS FOR A LABOR PROJECT MANAGEMENT AND COSTING SYSTEM AND PLATFORM (hereinafter “LPM PLATFORM”) transforms inputs (e.g., labor information, location information, activity data, login data, entry information, etc.) via LPM PLATFORM components (e.g., entry aggregator, labor monitoring component, fault tracking component, etc.) into outputs (e.g., user history reports, employee reports, entry reports, activity models, labor resource schemas, etc.). The LPM PLATFORM provides dynamic management, analysis and control of labor activity information and administrative protocols. In particular, this disclosure discusses the application of the LPM PLATFORMLPM PLATFORM to provide users with the ability to monitor employee activity, identify faulty activity, and manage the allocation of labor resources.

### PRIORITY CLAIM

Applicant hereby claims priority under 35 USC §119 for U.S. provisional patent application Ser. No. 61/420,235, filed Dec. 6, 2010, entitled “APPARATUSES, METHODS, AND SYSTEMS FOR A LABOR PROJECT MANAGEMENT AND COSTING SYSTEM AND PLATFORM.”

This patent application disclosure document (hereinafter “description” and/or “descriptions”) describes inventive aspects directed at various novel innovations (hereinafter “innovation,” “innovations,” and/or “innovation(s)”) and contains material that is subject to copyright, mask work, and/or other intellectual property protection. The respective owners of such intellectual property have no objection to the facsimile reproduction of the patent disclosure document by anyone as it appears in published Patent Office file/records, but otherwise reserve all rights.

### FIELD

The present invention is directed generally to an apparatuses, methods, and systems for managing labor activity, and more particularly, to APPARATUSES, METHODS, AND SYSTEMS FOR A LABOR PROJECT MANAGEMENT AND COSTING SYSTEM AND PLATFORM.

### BACKGROUND

Work may be conducted in a variety of ways, in a variety of locations, and may contain a varying workforce. The workforce's hours may be tracked through hour tracking timepieces.

### BRIEF DESCRIPTION OF THE DRAWINGS

The accompanying drawings illustrate various non-limiting, example, inventive aspects in accordance with the present disclosure:

FIG. 1 is a block diagram illustrating embodiments of the LPM PLATFORM;

FIGS. 2-5 are data flow diagrams illustrating aspects of some embodiments and implementations of the LPM PLATFORM;

FIGS. 6a-6j show example screen images illustrating various embodiments and implementations of the LPM PLATFORM;

FIG. 7 is of a block diagram illustrating embodiments of the LPM PLATFORM controller;

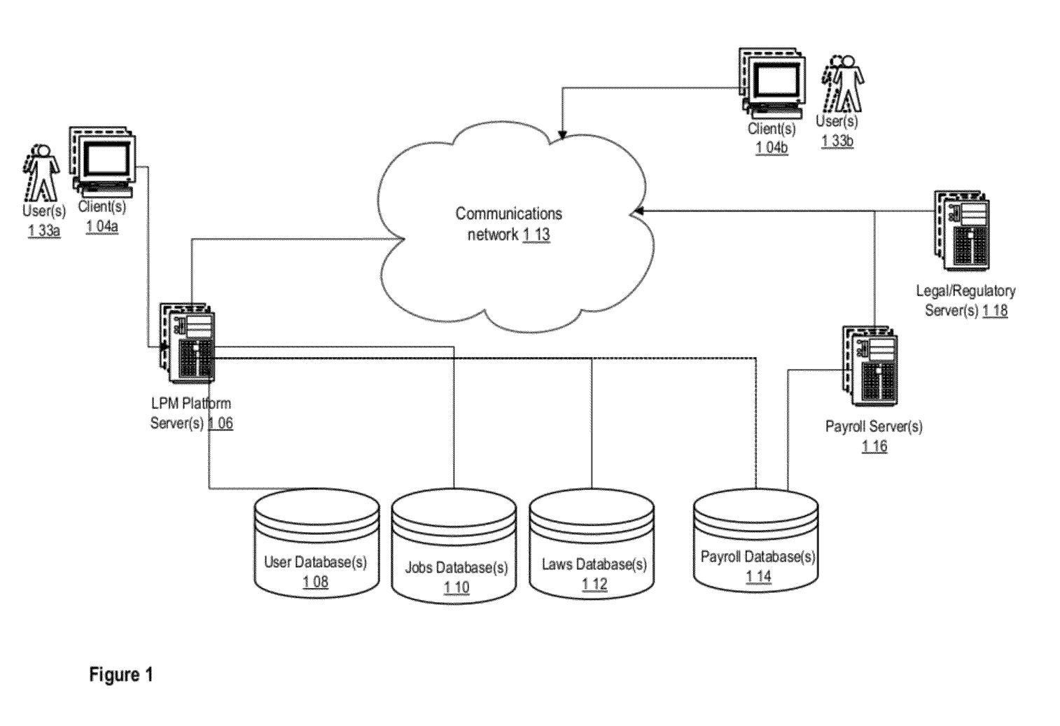

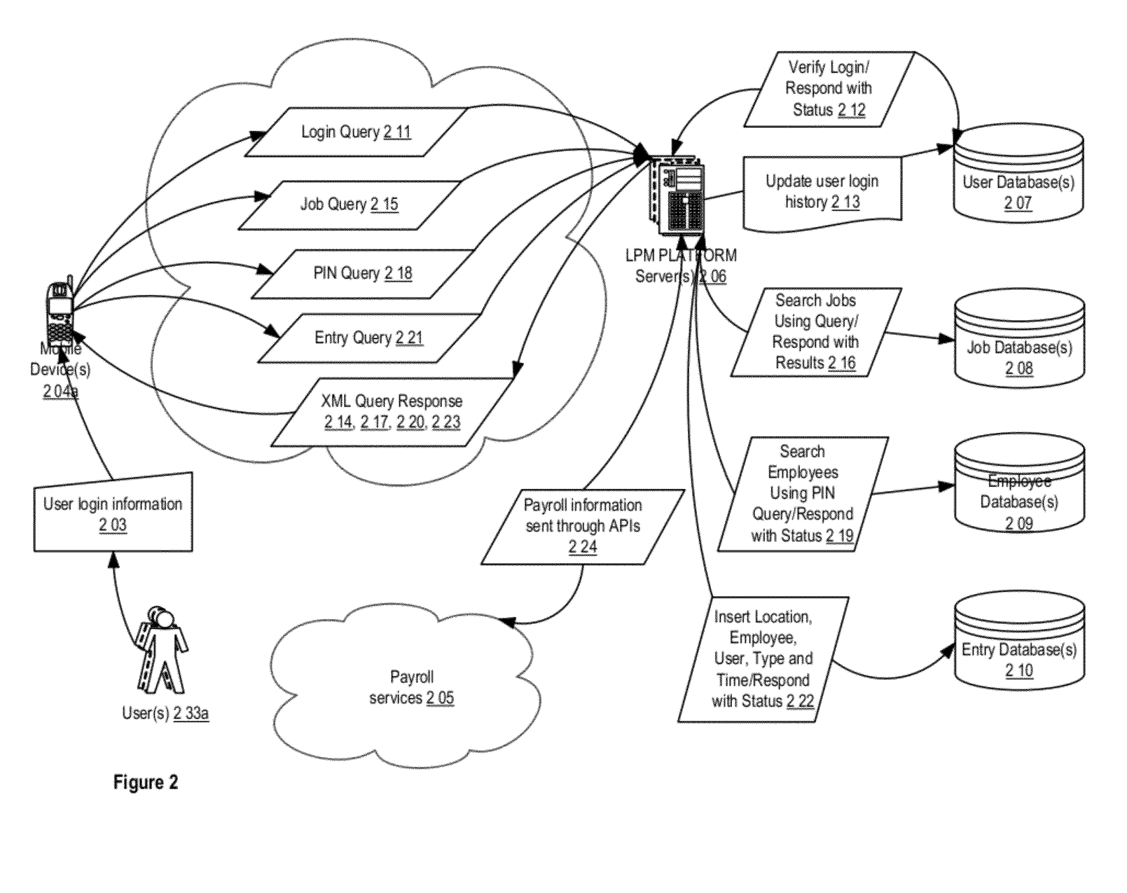

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

### LPM Platform

FIG. 1 provides an overview block diagram illustrating data flows between clients 104a, users 133a-b, and servers 106 116 118, via a communication network 113 for an embodiment of the LPM PLATFORM. In such an embodiment, a user or users 133a-b may interact with a LPM PLATFORM server 106 through a communication network 113. It is to be understood that the LPM PLATFORM server 106 is illustrated as a remote server by way of example only and that the LPM PLATFORM implementation may be customized based on the requirements of a particular entity, system administrator or user. User(s) may submit information and data values for processing through a user interface to the LPM PLATFORM server 106, payroll server(s) 116, legal and regulatory server(s) 118, and or the like, through a communication network. In another embodiment, a LPM PLATFORM server may be a local computer 104a so that a user may interact with it through user input devices (e.g., a keyboard, mouse, etc.) directly without remote access via a network. In another embodiment the LPM PLATFORM server may be a local server in an entity's administrative system with server(s). In another embodiment the LPM PLATFORM may be in direct communication with and updated a plurality of databases, such User databases 108, Jobs databases 110, Laws databases 112, Payroll databases 114, and/or the like. In yet another embodiment the LPM PLATFORM server may communicate with a plurality of mobile or remote embodiments 104b through a communication network.

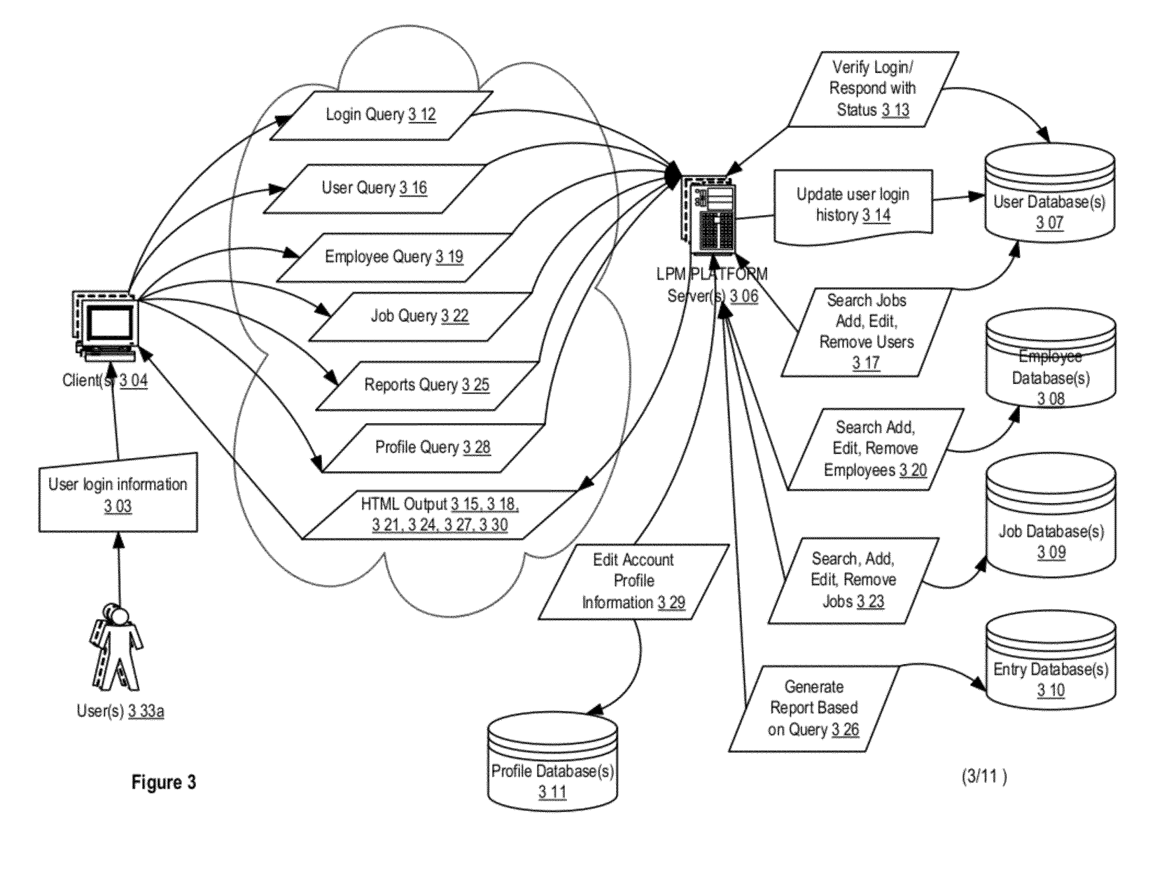

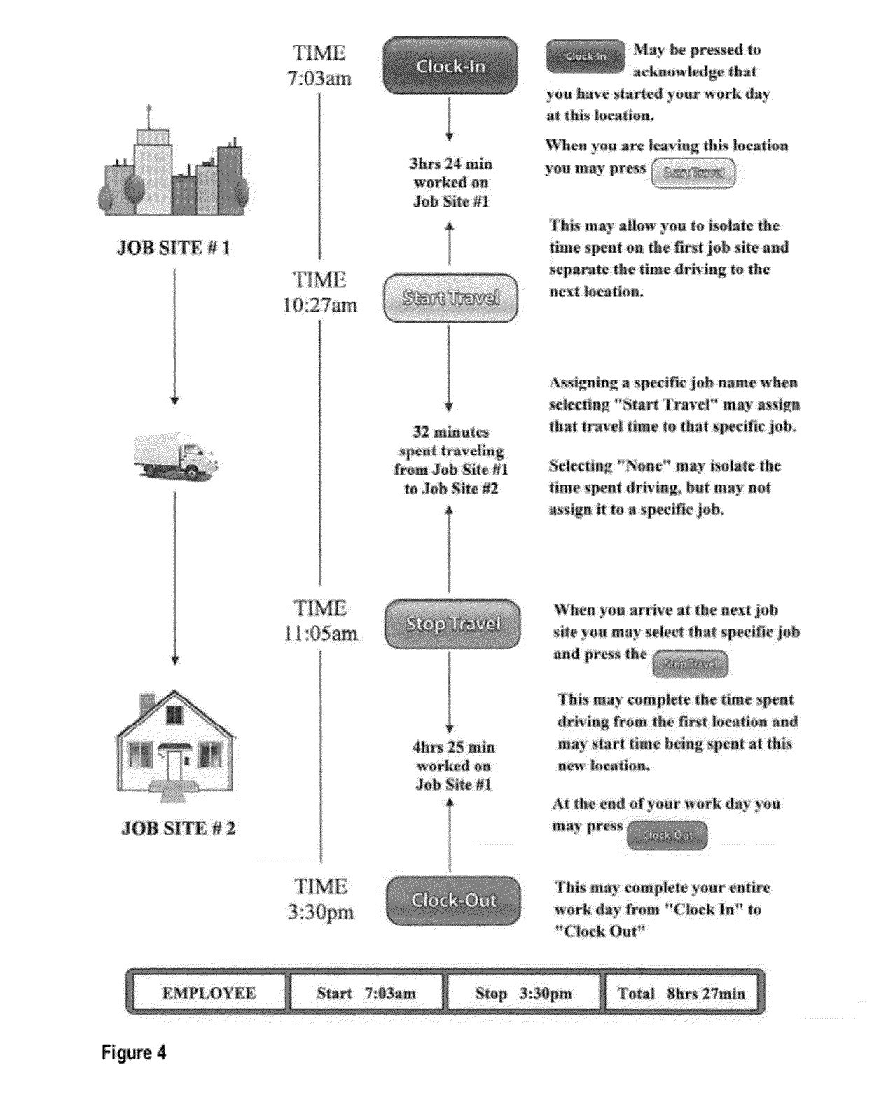

FIG. 2-4 provide process flow diagrams illustrating example implementations in some embodiments of the LPM PLATFORM. It is to be understood the processes illustrated in FIG. 2, FIG. 3, and FIG. 4 are not restrictive and may be customized based on the requirements of various user types including, and not limited to, employers, employees, field administrators, etc.

For example, FIG. 2 shows in some embodiments of the LPM PLATFORM a user 233a may provide user login information 203 with a mobile device 204a which may process and transmit a login query 211 to an LPM PLATFORM server 206. The LPM PLATFORM server may then verify the login query 212 with a user database 207 and may respond with the status of the login query 212. The LPM PLATFORM server may update the user login history with the status of the login query (i.e., verified, time stamp, etc.) 213. The LPM PLATFORM server may transmit an XML query response back to the user's mobile device 214 at which time the user may provide a job query to the LPT PLATFORM server 215. The LPM PLATFORM server may then search at least one job database 208 for jobs using the received job query and may respond with results 216. The LPM PLATFORM may respond to the mobile device query with an XML query response of the search results 217. A user may transmit a PIN query 218 via the mobile device to the LPM PLATFORM server which may then search for employees using the received PIN query 219. The LPM PLATFORM server may search an employee database 209 using the received PIN query and may respond 219 to the user with an XML query response 220. In some embodiments a user may be then transmit an entry query 221 to the LPM PLATFORM server. The LPM PLATFORM server may insert location, employee, user, type and time information to an entry database 210 and may then respond to the user with a status 222 of the entry query via an XML query response 223. In some embodiments the LPM PLATFORM server may transmit payroll information through APIs 224 to a variety of payroll services 205.

FIG. 3 shows in some embodiments of the LPM PLATFORM a user may provide user 333a login information 303 with client device 304 which may be used to transmit a login query 312 to an LPM PLATFORM server 306. The LPM PLATFORM may verify the received login information 313 with the user database 307 and the may respond with a status of the login query 315. The LPM PLATFORM server may also update the user's login history in the user database 314. The LPM PLATFORM server may receive a user query 316 from the user client device and may search, add, edit and remove user from the user database based on the user query 317. The LPM PLATFORM server responds to the user query with an HTML output with search results 318. The LPM PLATFORM server may receive an employee query from the user's client device 319 and may then search, add, edit and remove employees from employee database 308 based on the employee query 320. Thereafter, the LPM PLATFORM server may provide an HTML output to the user client device 321. The LPM PLATFORM may receive a job query 322 and search, add, edit, and/or remove job from a jobs database 309 based on the job query 323. The LPM PLATFORM server may provide job query results as an HTML output 324. In some embodiments of the LPM PLATFORM the LPM PLATFORM server may receive reports queries from the user client device 325, the server may also generate a report based on the report query 326 and an entry database 310. The LPM PLATFORM may then transmit a corresponding HTML output to the user's client device 327. The LPM PLATFORM server may also receive a profile query 328 and in response may edit account profile information 329 and update profile database accordingly 311. The LPM PLATFORM may then transmit a corresponding HTML output back the user's client device 330.

The above-described LPM process may also generate a login query, e.g., 211, 312, whereby, for example, the LPM PLATFORM server, e.g., 206, 306, may receive a HTTP(S) POST request similar to the example below:

```
POST /login_query.php HTTP/1.1
Host: www.LPMprocess.com
Content-Type: Application/XML
Content-Length: 788
<?XML version = “1.0” encoding = “UTF-8”?>
<LoginQuery>
<timestamp>2011-02-22 17:00:01</timestamp>
    <user_login>
        <user_ID>1234JS23</user_ID>
        <user_name>John Smith</user_name>
        <email>john.doe@work.com</email>
        <password>MyPassword</password>
    </user_login>
</LoginQuery>
```

The above-described LPM process may also generate a user query, e.g., 316, whereby, for example, the LPM PLATFORM server, e.g., 306, may receive a HTTP(S) POST request similar to the example below:

```
POST /user_query.php HTTP/1.1
Host: www. LPMprocess.com
Content-Type: Application/XML
Content-Length: 788
<?XML version = “1.0” encoding = “UTF-8”?>
<UserQuery>
<timestamp>2011-02-22 17:00:01</timestamp>
    <UserParam>
        <user_ID>1234JS23</user_ID>
        <user_name>John Smith</user_name>
    </UserParam>
</UserQuery>
```

The above-described LPM process may also generate a employee query, e.g., 319, whereby, for example, the LPM PLATFORM server, e.g., 306, may receive a HTTP(S) POST request similar to the example below:

```
POST /employee_query.php HTTP/1.1
Host: www. LPMprocess.com
Content-Type: Application/XML
Content-Length: 788
<?XML version = “1.0” encoding = “UTF-8”?>
<EmployeeQuery>
<timestamp>2011-02-22 17:00:01</timestamp>
    <employee_ID>123456</employee_ID>
    <employee_name>Employee Name</employee_name>
</EmployeeQuery>
```

The above-described LPM process may also generate a job query, e.g., 215, 322, whereby, for example, the LPM PLATFORM server, e.g., 206, 306, may receive a HTTP(S) POST request similar to the example below:

```
POST /job_query.php HTTP/1.1
Host: www. LPMprocess.com
Content-Type: Application/XML
Content-Length: 788
<?XML version = “1.0” encoding = “UTF-8”?>
<JobQuery>
<timestamp>2011-02-22 17:00:01</timestamp>
    <jobparam>
        <jobtitle>Current Job Title</jobtitle>
        <jobdetail1>Job Detail 1</jobdetail1>
        <jobdetail2>Job Detail 2</jobdetail2>
    </jobparam>
</JobQuery>
```

The above-described LPM process may also generate a PIN query, e.g., 218, whereby, for example, the LPM PLATFORM server, e.g., 206, may receive a HTTP(S) POST request similar to the example below:

```
POST /PIN_query.php HTTP/1.1
Host: www. LPMprocess.com
Content-Type: Application/XML
Content-Length: 788
<?XML version = “1.0” encoding = “UTF-8”?>
<PINQuery>
<timestamp>2011-02-22 17:00:01</timestamp>
    <PINparam>
        <jobtitle>Current Job Title</jobtitle>
        <user_ID>1234JS23</user_ID>
        <employee_name>Employee Name</employee_name>
        <user_name>JohnSmith2345</user_name>
        <email>john.doe@work.com</email>
        <PIN>X-digit PIN</PIN>
    </PINparam>
</PINQuery>
```

The above-described LPM process may also generate a entry query, e.g., 221, whereby, for example, the LPM PLATFORM server, e.g., 206, may receive a HTTP(S) POST request similar to the example below:

```
POST /entry_query.php HTTP/1.1
Host: www. LPMprocess.com
Content-Type: Application/XML
Content-Length: 788
<?XML version = “1.0” encoding = “UTF-8”?>
<EntryQuery>
<timestamp>2011-02-22 17:00:01</timestamp>
    <EntryParam>
        <location>Job Location</location>
        <employee_name>Employee Name</employee_name>
        <user_name>John Smith</user_name>
        <type>Entry type</type>
        <entry_time> 11:00AM </entry_time>
        <entry_param_1>Clock In</entry_param_1>
        <entry_notes>Entry Note</entry_notes>
    </EntryParam>
</EntryQuery>
```

The above-described LPM process may also generate a reports query, e.g., 325, whereby, for example, the LPM PLATFORM server, e.g., 306, may receive a HTTP(S) POST request similar to the example below:

```
POST /report_query.php HTTP/1.1
Host: www. LPMprocess.com
Content-Type: Application/XML
Content-Length: 788
<?XML version = “1.0” encoding = “UTF-8”?>
<ReportQuery>
<timestamp>2011-02-22 17:00:01</timestamp>
    <report_ID>123456</report_ID>
    <user_name>JohnSmith2345</user_name>
    <reportdate_start>12/12/2011</reportdate_start>
    <reportdate_end>03/12/2012</reportdate_end>
</ReportQuery>
```

The above-described LPM process may also generate a profile query, e.g., 328, whereby, for example, the LPM PLATFORM server, e.g., 306, may receive a HTTP(S) POST request similar to the example below:

```
POST /profile_query.php HTTP/1.1
Host: www. LPMprocess.com
Content-Type: Application/XML
Content-Length: 788
<?XML version = “1.0” encoding = “UTF-8”?>
<ProfileQuery>
<timestamp>2011-02-22 17:00:01</timestamp>
    <profile_ID>123456</profile_ID>
    <user_name>JohnSmith2345</user_name>
</ProfileQuery>
```

The above-described LPM process may generate a query response, e.g., 214, 217, 220, 223, 315, 318, 321, 324, 327, 330, whereby, for example, a client or server computer, e.g., 204, 304, may receive a HTTP(S) POST message similar to the example below:

```
POST /QueryResponse.php HTTP/1.1
Host: www. LPMprocess.com
Content-Type: Application/XML
Content-Length: 788
<?XML version = “1.0” encoding = “UTF-8”?>
<query_response>
<timestamp>2011-02-22 17:00:01</timestamp>
    <login_status>Login Successful</login_status>
    <job1_result>Job 1</job1_result>
    <job1detail>Job 1 Detail</job1detail>
    <job2_result>Job 2</job2_result2>
    <job2detail>Job 2 Detail</job2detail>
    <PIN_status>PIN accepted</PIN_status>
    <time_entry>
        <employee_name>Employee Name</employee_name>
        <time_entry_action1>Clock In</time_entry_action1>
        <time_entry_action2>Travel</time_entry_action2>
        <time_entry_action3>Clock Out</time_entry_action3>
    </time_entry>
    <entry_summary>
        <entryID>12345982</entryID>
        <Entry_status>Entry Successful</Entry_status>
        <action1>Enter Another Pin</action1>
        <action2>Select Another Job</action2>
        <action3>Login Another Account</action3>
    </entry_summary>
    <report>
        <report_title>Report Title</report_title>
        <employee_name>Employee Name</employee_name>
        <clock_in_start>7:03am</clock_in_start>
        <stop_1>3:30pm</stop_1>
        <total_time_hours>8 Hours</total_time_hours>
        <total_time_minutes>27 min</total_time_minutes>
        <total_travel_time_hours>0 hours<total_travel_time_hours>
        <total_travel_time_minutes>32 min
        <total_travel_time_minutes>
        <JobSite_name1>Job Site #1</Jobsite_name1>
        <JobSite_name2>Job Site #2</Jobsite_name2>
    </report>
</query_response>
```

FIG. 4 shows another process flow diagram of some LPM PLATFORM embodiments through time markers. For example, at 7:03 AM a user may “clock-in” to Job Site #1 and may depart the site to start travelling to Job Site #2 at 10:27 AM. In some embodiments, the user may select “Start Travel” on his or her client device or the job site client device to denote they are en route to Job Site #2. While travelling some LPM PLATFORM embodiments may keep track of the expected travel time between job sites and/or track the actual travel time between job sites for a user. With respect to the latter the user may select “Stop Travel” at Job Site #2 once he or she has arrived, (i.e., 11:05 AM). Once the user has completed their workday he or she may clock-out by selecting “Clock-Out” on an applicable client device/interface (i.e., 3:30 PM). In some embodiments the LPM PLATFORM may automatically determine the time worked at each site and times travelling based on the user's selections of “clock-in,” “start travel,” “stop travel,” “clock out,” and/or the like.

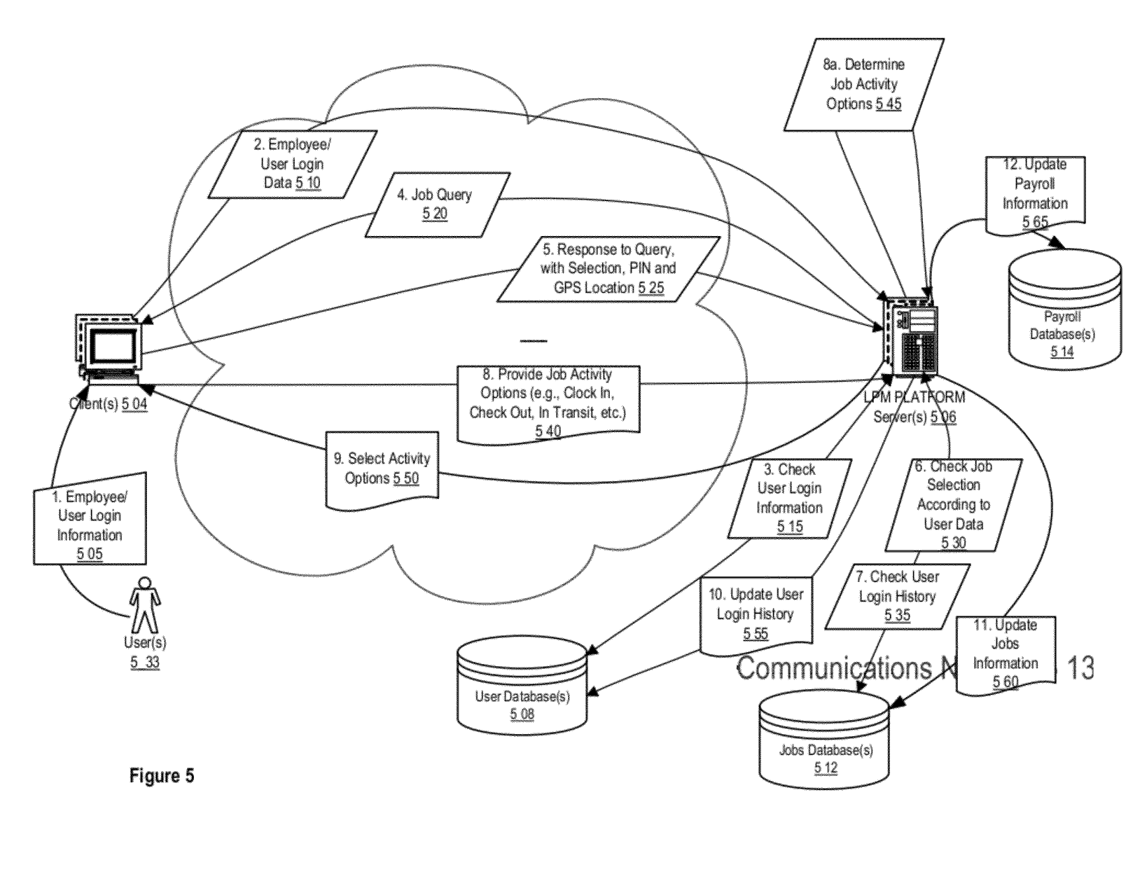

FIG. 5 provides another process flow diagram illustrating an example implementation in some embodiments of the LPM PLATFORM. It is to be understood the process illustrated in FIG. 5 is not restrictive and may be customized based on the requirements of various user types including, and not limited to, employers, employees, field administrators, etc. In some embodiments of the LPM PLATFORM a user 533 logs in by providing an e-mail and a personal PIN 505 to a client device 504. The LPM PLATFORM server may receive the employee user login data 510 and check the user login information 515 against a user database 508. Once this information is entered and verified a screen may pop up querying the user for a job name derived from a listing of predetermined job names 520. The user may enter the job name, choose to search through all pre-loaded, predetermined jobs and job names, or select “None” 525. In some embodiments selecting “None” follows the same activity as having selected a job or job name except the derived activities are expanded to include all possible activities across all jobs. Once the proper job is selected the user may then enter his/her personal PIN 525. The LPM PLATFORM server may check the job selection according to user data 530 and check the user's login history 535 against a jobs database 512 and in some embodiments the user database 508. Once checked an activity screen may be presented which will present the user with various choices 540, for example, some choices may comprise “Clock In,” “Travel” and “Clock Out.” In some embodiment the LPM PLATFORM may also at this point check login history and omit incorrect choices from the presented activity screen 530 535 545. For example, a user who has previously “Clock[ed] In” within a particular time period may not be presented with the option to “Clock In” again. In another example, if “Clock In” is the only correct action then the LPM PLATFORM may remove all of the other action choices. When an activity such as “Clock In” is chosen, the location of the activity may be determined and transmitted to a LPM PLATFORM website. The transmitted information may show what job the user is on at a specific time and exactly where he/she may be. A flag may be generated if the user is outside of a predetermined location, and said flag may be transmitted to an administrator and/or employer to notify the administrator and/or employer of the fault activity.

In another embodiment of the LPM PLATFORM once the user selects the correct job, inputs his/her personal PIN and selects an activity 550, the mobile device may be handed to the next employee. The next employee may be presented with a screen comprising options rendered in a selectable graphical format (e.g., buttons, etc.) and labeled, “Enter Another PIN,” “Choose Another Job”, “Log In to Another Account,” and/or the like. In some embodiments “Enter Another PIN” allows the employee to put in his/her personal PIN and select an activity (e.g., “Clock In,” “Travel, “Clock Out,” etc.). With each employee the job and determined locations may be immediately displayed on a LPM PLATFORM website. In some embodiments “Choose Another Job” may provide the user with the option to login an activity at another job or worksite. In some embodiments “Log In to Another Account” may be an option that provides the user with the ability to manage multiple accounts on a single mobile device. If another account is chosen the user may enter his/her e-mail and personal PIN corresponding to the other account.

In some embodiments of the LPM PLATFORM when an activity is selected, the exact time and location may be determined and may be immediately displayed on a LPM PLATFORM website. This information allows the employer (e.g., office user, administrator, etc.) to see exactly who is on the job and at exactly what time the employees arrived. The LPM PLATFORM server may then update user login history 555, update jobs information 560 and/or update payroll information 560.

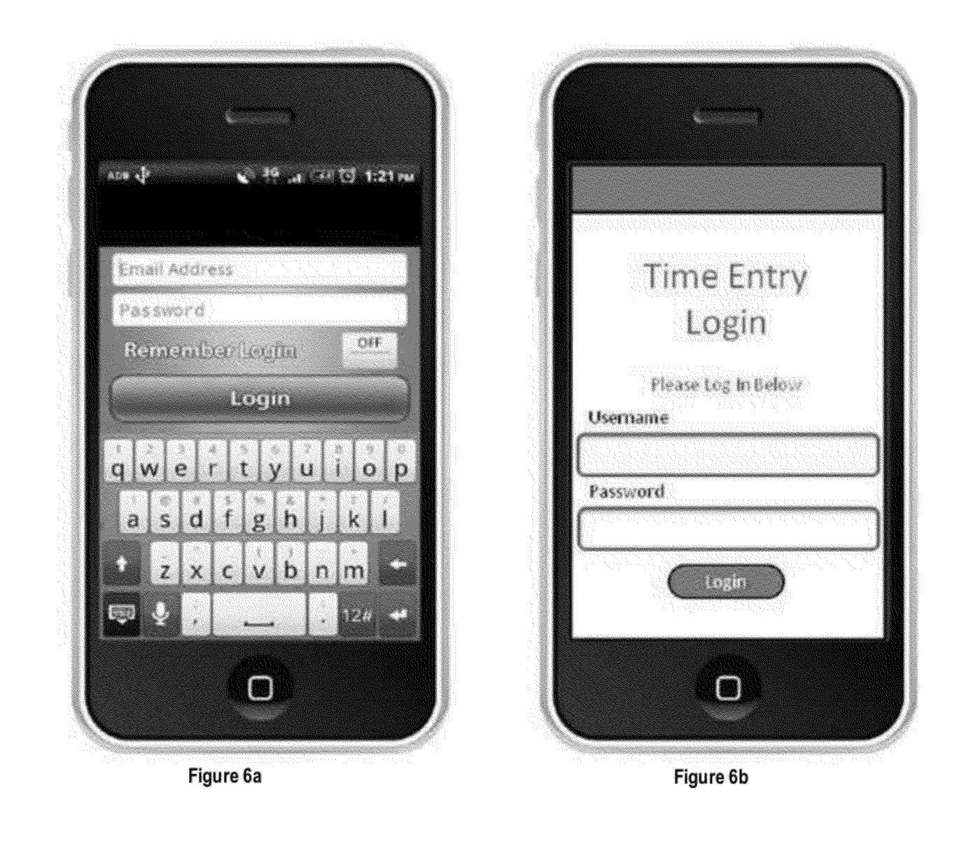

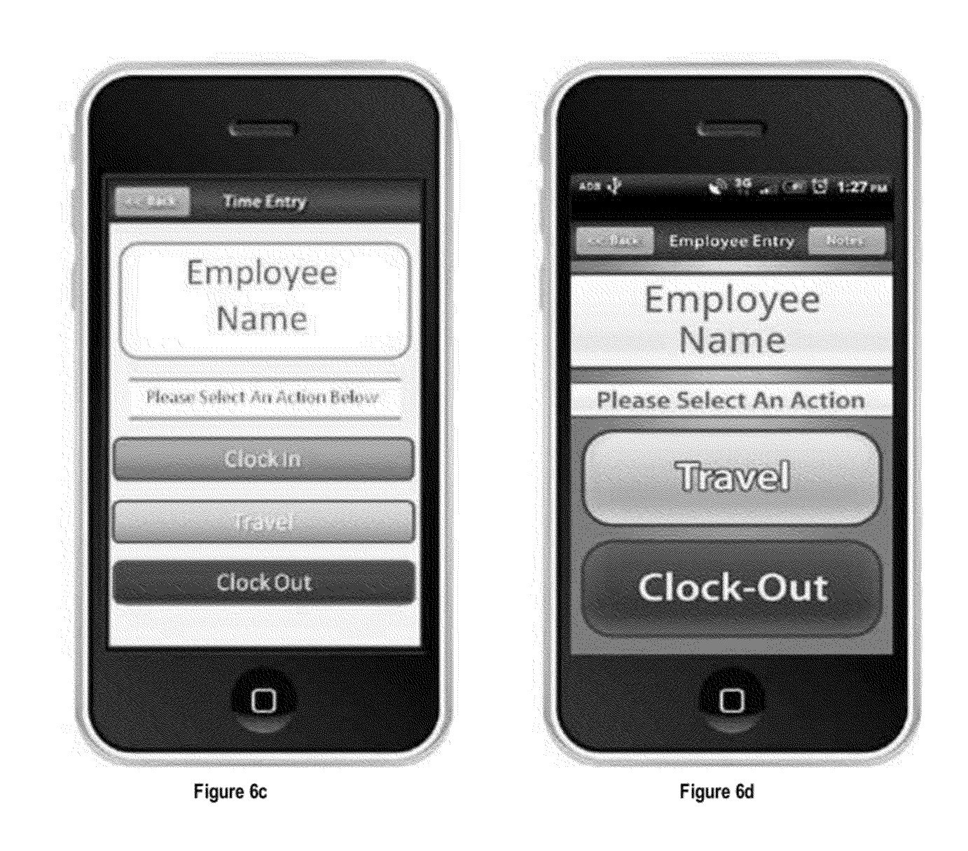

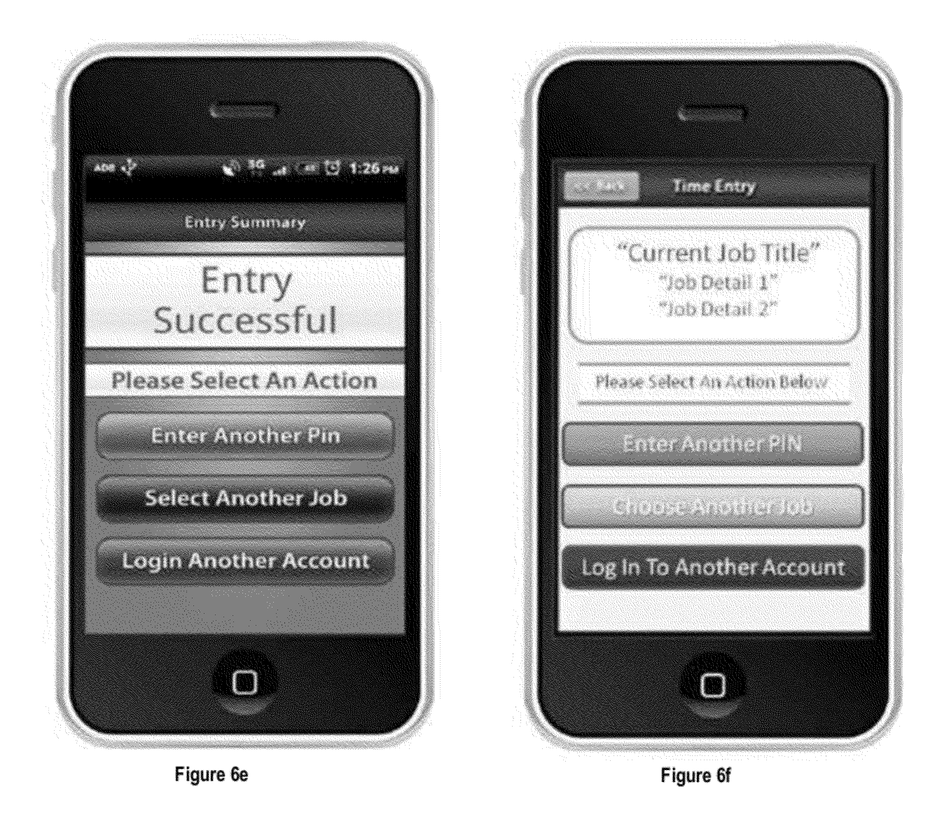

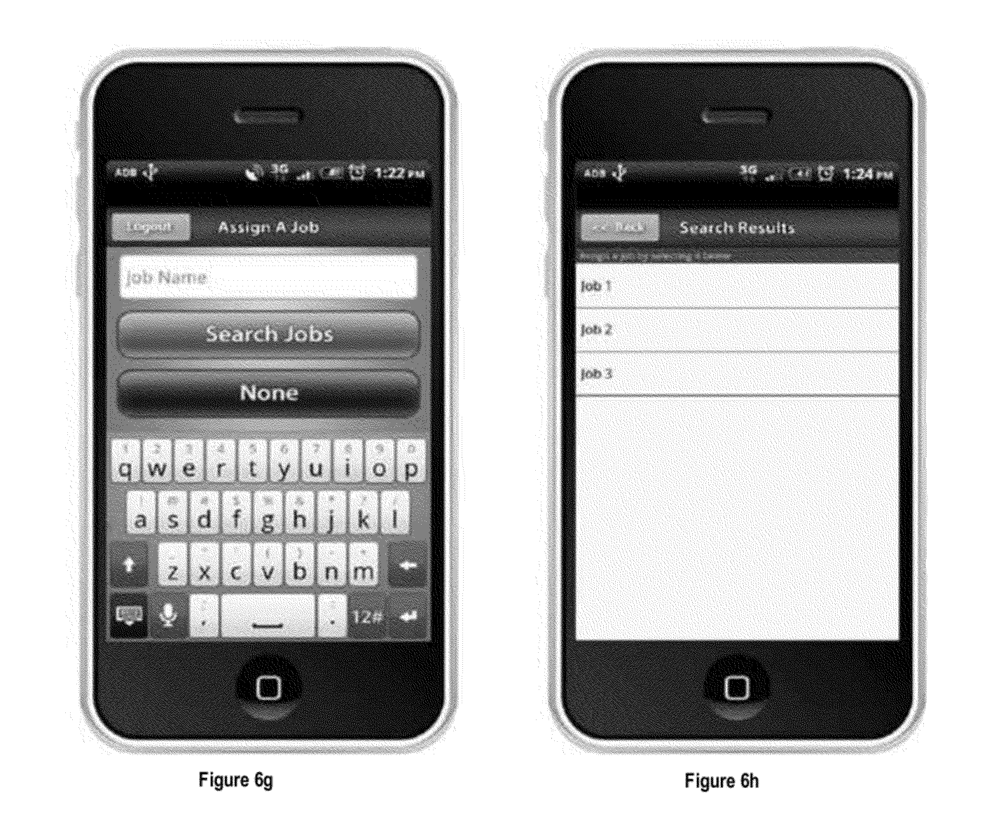

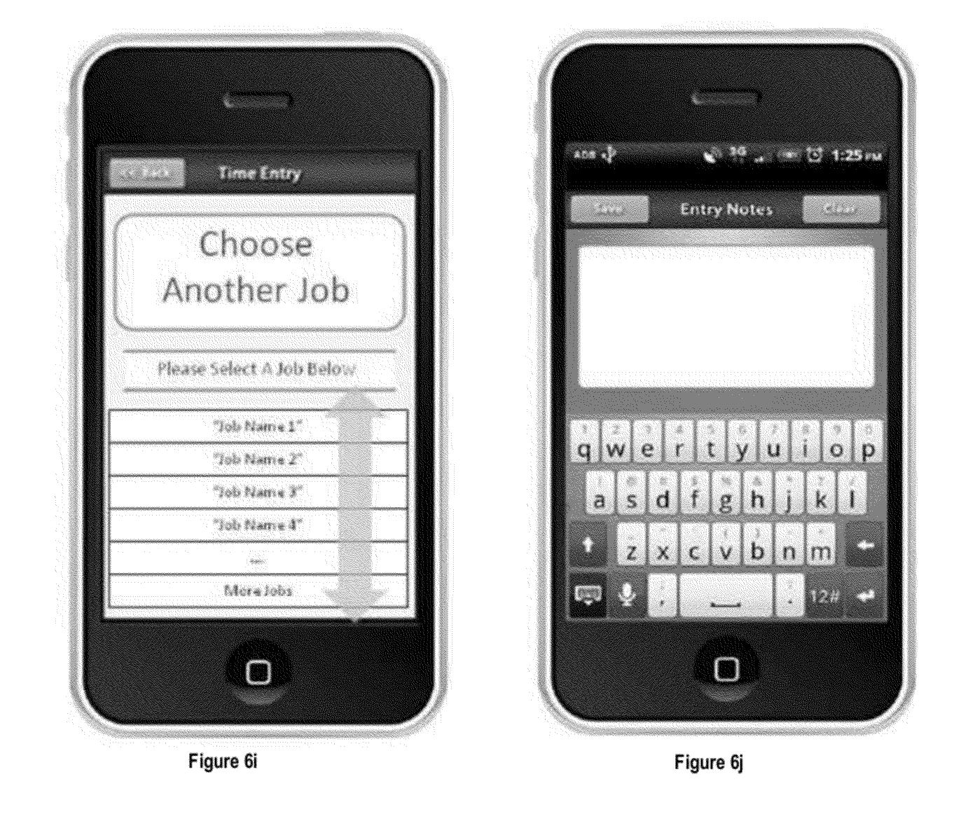

FIGS. 6a-6j show exemplary screen images illustrating various embodiments and implementations of the LPM PLATFORM. FIGS. 6a-6b show implementations of the LPM PLATFORM wherein LPM PLATFORM data is organized into a mobile embodiment and presents to the user a login query. FIGS. 6c-6d show implementations wherein a user has logged in and is being presented with a job activity options. FIGS. 6e-6f show other implementations where, for example, a new user at a current job/work site may be presented with activity options pertaining to a given job/work site. In some implementations the shown screen may be displayed after a previous user has already logged into the LPM PLATFORM. FIG. 6g shows another implementation of the LPM PLATFORM as a mobile embodiment where a user has elected to choose another job. FIGS. 6g-6h show job search/assignment and search/assignment results implementations of the LPM PLATFORM. FIG. 6i shows an example of job listings, which may be scrollable using various navigation gestures. FIG. 6j shows a note entry implementation, where a system, for example, may enter provide notes associated with a job, assignment or activity entry.

Some embodiments of the LPM PLATFORM may be configured to contain various account levels which may be associated with a system user's access and privileges. In some embodiments they may be two account users, for example one level may be provided be assigned to user accounts and the other level may be assigned to employee accounts. Further to said embodiments comprising two account levels, one account level may contain varying access privileges greater than another account level.

In some embodiments user accounts may be higher account levels than employee accounts, as a result user accounts may also have higher system priority over employee accounts which may extend beyond access privileges and may include various system features as perceived by a system user. For example, in some embodiments, an employee account may be restricted to “Clocking in,” “Clocking out,” designating “Travel”, activating said employee account, etc. While, further to the example, user accounts may have features greater than and inclusive of features afforded to a lesser account level which may include auditing employee accounts, “Clocking in” lesser accounts, “Clocking out” lesser accounts, designating “Travel” for lesser accounts, and/or the like.

Some embodiments of the LPM PLATFORM may be configured to generate accounts for users (e.g., employers, employees, etc.) based on received user information (e.g., company name, your name, e-mail address, job title, designation, etc.). Generated user accounts may include user-specific usernames, email addresses, passwords and/or 6-digit PINs, etc. In some embodiments the generated account may be associated with trials (e.g., 30 days, 90 days, etc.) comprising various levels of access (e.g., limited access, admin only access, full access, etc.).

Some embodiments of the LPM PLATFORM may be configured to generate employee accounts based upon received employee information. In some embodiments, said employee information may comprise an employee's full name, time zone that they are working in, a photo, job title, designation, etc. Such embodiments may generate a 6-digit PIN for each employee based on the received information. The 6-digit PIN (i.e. personal PIN) may be selected by the employee, employer (e.g., office user, etc.), or it may be generated randomly. In another example, the personal PIN may be generated from various permutations of the employee's received information. In some embodiments of the LPM PLATFORM safeguards may be in place to restrict duplicate PIN numbers from being generated. In some embodiments employee information may be received via a mobile device. For example, an employee may update their account photo by capturing their image using the camera of a mobile device and submit said photo through the LPM PLATFORM.

Some embodiments of the LPM PLATFORM may be configured to have two account levels wherein a user account maintains one level and employee accounts maintain another lever. In such embodiments user accounts may be assigned passwords while employee accounts may be assigned PINs.

Some embodiments of the LPM PLATFORM may be configured to associate passwords and PINs of various lengths, combinations with system accounts.

In some embodiments the LPM PLATFORM may be configured to query the system user for credit card information upon completion of a trial type (e.g., 30 day “No Obligation” trial,” etc.) to continue using the LPM PLATFORM embodiment.

Some embodiments of the LPM PLATFORM may be configured to receive logins from system users at remote locations via a plurality of mobile devices. In such embodiments, a user may be an employee away from the office. The employee may access the LPM PLATFORM embodiment on a mobile device and login to LPM PLATFORM embodiment using their email address, a predetermined (i.e. previously generated) username, and password (i.e., personal PIN).

Some embodiments of the LPM PLATFORM may be configured to require photo verification of the employee upon login. Such embodiments of the LPM PLATFORM may be configured to reliably verify employee photos across a plurality of mobile devices possessing camera features. For example, in some embodiments of the LPM PLATFORM, if the camera of a mobile device is on the front of the mobile device a countdown delay may be programmed for a certain period of time to provide time for an employee to take a photo. In another example, if the camera is located on the opposite side of the device then a longer countdown period may be provided to provide an employee more time to appropriately orient the camera and take the photo. In such embodiments, once the photo has been taken a prompt may be presented querying the user to either accept or reject the photograph. If accepted the image may be retained and matched to the employees corresponding account. If the image is rejected then the countdown process may be repeated until the employee accepts.

Embodiments of the LPM PLATFORM may be configured to simultaneously run visual recognition software. For example during the login if a photo has been accepted by an employee the platform may check the photo against the corresponding photo under the employee's account. If the taken photo fails the check the attempt may be flagged and an administrator (e.g., office user, field administrator, etc.) may be notified. In some embodiments of the LPM PLATFORM an administrator may be able to manually pass or fail the image before login has been accepted and payroll has been processed. As an employee's image changes over time the administrator may have the option of updating the source match image to reduce false alerts.

In some embodiments of the LPM PLATFORM a single mobile device may be used to track a plurality of employees. In such embodiments of the LPM PLATFORM a primary user may be assigned to a mobile device and said primary user may be required to be associated with a particular job title or designation (e.g., field administrator, foreman, etc.). Said job title or designation may be verified during the user's login to the LPM PLATFORM. In such embodiments of the LPM PLATFORM the primary user may be associated with various levels of access to features and privileges of the LPM PLATFORM. For example, with respect to levels of access, the primary user may be the only person capable of accessing the LPM PLATFORM through the mobile device. Tracking a plurality of employees through some embodiments of the LPM PLATFORM may include accepting and declining employee logins on the mobile device; receiving and reassigning employee jobs; updating the predetermined location of an employee to match a new location; and/or the like.

Some embodiments of the LPM PLATFORM may be configured to periodically collect and receive job information comprising job locations, routes, job codes, SIC codes, etc. from a variety of sources including the employer entries, employer databases, payroll databases, and/or the like. Embodiments of the LPM PLATFORM may be configured to analyze job information and determine employee job assignments based on employee login locations, employee workload, employee attendance, and/or the like. Some embodiments may be configured to provide a “man power alert” wherein a worksite or job assignment has been determined to be under resourced or in crisis. The alert may allow the user (i.e., administrator) to locate labor/workforce resources in geographic proximity to the job/worksite in need and may be able to dispatch a predefined, or administrator defined, amount of workforce to the location in need. In some implementations dispatch of resources may be executed via text message, multimedia message, or voicemail via mobile embodiments of the LPM PLATFORM to other users.

In some embodiments of the LPM PLATFORM retrieved job information, employee activity information and/or the like may be used to compile job specific, employee specific and/or date specific reports.

Some embodiments of the LPM PLATFORM may be configured to monitor faulty employee activity and provide alert notifications to administrators regarding said faulty employee activity. In some embodiments of the LPM PLATFORM faulty activity rules may be periodically updated by administrators and/or user with appropriate privileges support auditing implementation s of the LPM PLATFORM.

Some embodiments of the LPM PLATFORM may be configured to synchronously update mobile LPM PLATFORM applications across a plurality of mobile devices. In some embodiments updates to mobile applications may be specified according to employer, employee titles, location, job type, etc.

Some embodiments of the LPM PLATFORM may be configured to automatically “Clock Out” employees who walk off a job and neglect to “Clock Out.” Said automatic “Clock Out” may be modified by users with predetermined privileges.

In some embodiments of the LPM PLATFORM an “In Transit Mode” may be provided to notify an administrator when an employee is leaving a work site to arrive at another work site. For example, a worker may enter his/her personal PIN and may select the “In Transit Mode” option which records their location and alerts the administrator that they are leaving the job site for another location. Once the employee has arrived at the next work site the employee may log back in with his/her personal PIN which records their location and confirms the arrival with the administrator. In some embodiments the employee may be able to define the destination work site after selecting “In Transit Mode” to provide the administrator with an indication of where he/or she is headed.

Some embodiments of the LPM PLATFORM may be configured to mapping applications to display LPM PLATFORM data and provide graphical representations of LPM PLATFORM implementations. Embodiments of the LPM PLATFORM may be configured to operate with global positioning systems (GPS) (e.g., GPS on a mobile devices, GPS receivers, etc.) and may interact with the GPSs to provide location specific LPM PLATFORM data (e.g., location elements, user network locations, etc.), historical user data, system activity tracking data, and/or the like. For example, some implementations may configure mapping solutions to detail labor resources across a user defined location (e.g., region, jurisdiction, etc.), a predetermined location, a LPM PLATFORM generated location, and/or the like.

Some embodiments of the LPM PLATFORM may be configured to generate profiles of various for system accounts. These profiles may contain various levels of information comprising account owner's name, address, job type, current location, etc. These profiles may also be customized by system users in accordance with their account level and associated account level privileges. Customization may include profile sharing with other system users, business-to-business configuration options, profile editing, account/colleague invitations, and/or the like.

Some embodiments the LPM PLATFORM may be configured to provide labor law notifications and employment policy notification. For example, employment policy notification requirements may be sent to the workforce through the LPM PLATFORM. Employees may read through the notification and confirm that they have read the notification by selecting “YES” or “NO” and enter their personal PIN. If “YES” has been selected the Employees' photographs may be taken and stored on file within the LPM PLATFORM. If “NO” has bee selected a fault is produced which alerts the administrator that a given employee needs help in understanding the notification. This feature provides proof that an organization has complied with labor law notification requirements.

Some embodiments of the LPM PLATFORM may be configured to operate according to “cloud” based computing architecture. As a non-limiting example, some embodiments the LPM PLATFORM may be configured to store data collected, generated, and/or manipulated in the field via various mobile devices and/or client devices to a LPM PLATFORM server(s) using internet connections and/or the like.

In some embodiments the LPM PLATFORM may be configured to undertake a peer-to-peer computing architecture whereby users are associated with various degrees of hierarchical privilege and access.

In some embodiments of the LPM PLATFORM LPM PLATFORM time may be separate and mutually exclusive from a clock/time locally operated on a mobile device, computer, etc. LPM PLATFORM time may defined on a LPM PLATFORM clock according to coordinated universal time (UTC) standards which may operate separately from any mobile/client device, user, and/or system. As a non-limiting example, a user of the LPM PLATFORM may be able to operate an implementation of the LPM PLATFORM via their personal mobile device to “Clock In” however the user's LPM PLATFORM activity may be metered/tracked according to a LPM PLATFORM clock (e.g., UTC standard time) residing on a LPM PLATFORM server, within a remote LPM PLATFORM component, and/or the like. As another non-limiting example, in some embodiments, if a user attempts to manipulate the time within an LPM PLATFORM embodiment and/or implementation an LPM PLATFORM administrator may be notified. In another similar example a fault tracking component may be notified.

In some embodiments, the LPM PLATFORM may be configured to utilize UTC standard time associated with utilized global positioning systems.

Some embodiments of the LPM PLATFORM may be configured to multiple languages (e.g., Spanish, English, etc.).

Some embodiments of the LPM PLATFORM may be configured to a plurality of security parameters and protocols (e.g., EVSSL, etc.).

Some embodiments of the LPM PLATFORM may be implemented over an open architecture in accordance with LPM PLATFORM security parameters.

Some embodiments of the LPM PLATFORM may be downloaded to, and may operate on mobile devices (e.g., Android devices, iOS devices, Blackberry devices, etc.).

Some embodiments of the LPM PLATFORM may be configured to provide globally accessible implementations of the LPM PLATFORM via websites, mobile applications, and/or the like.

Some embodiments of the LPM PLATFORM may be configured to synchronize mobile embodiments and implementations instantly with server based embodiments (i.e. websites).

Some embodiments of the LPM PLATFORM may be configured to login users via fingerprint scanning and verification.

Some embodiments of the LPM PLATFORM may be configured to accounting and invoicing applications providing users with management of billing procedures and activities.

In some embodiments of the LPM PLATFORM, to set up an account a user may be asked to enter some basic information (company name, your name, e-mail address and a password). Once this information is entered full access is granted to the back-end for a 30 day “no obligation” trial. The LPM PLATFORM application may be downloaded (free of charge) onto any Android, I Phone or Blackberry device, simply by going onto the mobile marketplace. In order to use the LPM PLATFORM, the office (user) may enter in each employee's full name, time zone that they are working in and generate a 6-digit PIN for each employee. This personal PIN can be selected by the employee/employer or it can be generated randomly. In some embodiment safeguards are in place to restrict duplicate PIN numbers. A photo of each employee may be entered into the system for photo verification when using the PDA.

Another aspect of the LPM PLATFORM may include a photo verification feature that may work reliably across many devices (open architecture) that may have a camera function of the front or back of the phone. For example, if the camera is on the front of the phone then a countdown delay may be programmed for a certain period of time before a photograph is taken. If the camera is located on the opposite side of the device then a longer count down period may be provided so that the user may have time to turn the phone around and take the picture. In some embodiments there may be a prompt provided to either accept or reject the quality of the photograph. If accepted the image may be retained and matched to the employees stored image file. If the image is rejected then the countdown process may be repeated until the employee accepts/approves of the resulting image.

In some embodiments visual recognition software may run in the background of the program and may flag failed facial recognition matches. The administrator may manually pass/fail images before login is accepted and payroll is processed. As an employee's image changes over time the administrator may have the option of updating a source match image to reduce false alerts.

In some embodiments one device (e.g., mobile device, etc.) may be used to track a plurality of chosen people. The person responsible for the phone (i.e., foreman, and/or the like) may have their e-mail in addition to their PIN set up in the system so that when an LPM PLATFORM online interface (i.e., website, web application, etc.) is accessed from the phone, there is only one person that can access the interface through e-mail confirmation. The application may remember this user/employee and may not require the e-mail entry ever again.

Job locations, routes, job codes, SIC codes, etc. may be entered into the back-end by an administrator. In some embodiments this information may be necessary to compile times into job specific, employee specific and date specific reports. This information may be added on a daily basis.

In some implementations of the LPM PLATFORM using a mobile device a user may press an LPM PLATFORM icon will bring the user to a screen that may require an e-mail and a personal PIN. Once this information is entered a screen may be displayed asking for a job name (i.e., the job names may be created originally by the administrator/office). The user may enter the job name, choose to just search through all jobs that were pre-loaded into the system or select “None”. Selecting “None” records all of the same activities but the information is not assigned to a specific job. Once the proper job is selected the user may then enter in his/her personal PIN. This may bring up an activity screen which may give choices such as “Clock In,” “Travel” and “Clock Out.” The LPM PLATFORM may recognize incorrect choices (e.g., clocking in and then clocking in again, etc.) and eliminate them from the screen. If “Clock In” is the only correct action then the system may remove all other actions, this eliminates the possibility of a mistake that may require the administrator/office to investigate and resolve. In some embodiments when an activity such as “Clock In” is chosen, GPS may confirm the location of the activity and send this information to the LPM PLATFORM website. This information may show what job a user is on at a specific time and exactly where he/she is. A prioritized colored flag may be generated if the user is outside of the predetermined GPS location (i.e., the watch dog). This may allow the office to know that the user is not where he/she is supposed to be.

Once the user selects the correct job, puts in his/her personal PIN and selects an activity, the device may be handed to the next employee. The employee is faced with a screen on the PDA that may have 3 buttons, “Enter Another PIN,” “Choose another Job” and “Log In to Another Account.”

“Enter Another PIN” allows the employee to put in his/her personal PIN and select an activity (i.e., clock in, travel or clock out, etc.). With each employee the job and location may be immediately displayed on the website which can be accessed from anywhere with an internet connection.

“Choose Another Job” may be selected if it were necessary to log in an activity at another job. The same steps would follow.

“Log In to Another Account” is an option that may give users the ability to have multiple accounts managed by one device. When another account is chosen the user may enter his/her e-mail and personal PIN corresponding to another account.

When an activity is selected, the exact time and location are immediately displayed on the LPM PLATFORM website. This information may allow the office to see exactly who is on the job and at exactly what time.

Upon completion of the 30 day “No Obligation” trial, the customer may be asked to enter in their credit card information in order to continue using LPM PLATFORM.

In some implementations of the LPM PLATFORM reports may be produced. In such implementations as activities are performed information may be instantaneously displayed on the LPM PLATFORM website. Today's activities may be easily viewed on a “Dashboard” or brief summary report simply showing who is on the job, what time they got there, and the GPS confirmation of the location.

There may be several reports available including but not limited to “Dashboard” reports, “Daily” reports, “Weekly” reports, “Monthly” reports, and/or the like.

Reports may also be customized and any report may be saved in a “Favorites” section. All of the information contained in these reports may be used to perform specific searches (i.e., search for a specific employee on a specific job on a specific day, etc.). The search queries may be endless, making it simple for a user to obtain the information they want and need.

Weekly report summaries may be exported into Excel spreadsheets or PDF files. Embodiments of the LPM PLATFORM may be integrated with Quickbooks and other accounting and payroll applications, making the payroll process fast and easy. Embodiments of the LPM PLATFORM may be fully integrated with a Payroll Service Bureau (i.e., PayChecks, PSP, ADP, etc.) for streamlined reporting and payroll processing.

Embodiments of the LPM PLATFORM may provide various additional features and benefits. In some embodiments the LPM platform may include EVSSL security protecting all information. Some embodiments the LPM platform may be used with a PDA to track time and location. Some implementation of the LPM PLATFORM may operate on the “Cloud.” This means that a user may not have to install any software on a computer. All of the information may be stored forever on the “Cloud.” All updates may be sent out through the “Cloud” updating each PDA instantly, making updates easy.

Implementations of the LPM PLATFORM may be accessed from anywhere in the world via websites, web applications, and/or the like. In these embodiments a user or client may not need to be in an office to see what's going on in the field. Implementations of the LPM PLATFORM may be structures as software as a service (SAAS) business model. Implementations of the LPM PLATFORM may include a watchdog system which may alert faults eliminating the manual auditing of the system by an administrator. Watchdog systems may allow organizations to increase scalability by directing the responsibility of auditing the metrics to the rules created by the administrator. In some embodiments, faults may be solely flagged allowing the administrator to address only those employees not conforming to the employment policies set in place.

In some embodiments of the LPM PLATFORM an auto clock out feature may ensure the workforce is paid only for the hours budgeted by the administrator. If overtime has not been approved then the PDA may alert the employee that they are being clocked out and it may record their location. If approved by the administrator members of the workforce may be granted permission to clock back in and work their desired overtime hours. In some embodiments auto clock out may protect against workers who walk off the job and forget to clock out. This feature may alert the employee(s) that they are being clocked out and may record their location (whether the employee is off the job site or still on the job site). In some embodiments of the LPM PLATFORM a man power alert function (or an administrative all man power call feature) may allow the administrator to locate the workforce geographically in relation to the need and dispatch the workforce to the location which is in a crisis.

In some embodiments of the LPM PLATFORM an In Transit mode may be selected when a worker leaves the job site to report to the next job site an in transit option. In such embodiments a worker may enter their pin number into a client device (i.e., PDA, etc.) to select the function which records their location and alerts the administrator that they are leaving the job site for another location. Once the worker has arrived at the next job site the worker logs back in with their pin number which records their location to confirm arrival with the administrator. Embodiments of the LPM PLATFORM may be available in multiple languages (e.g., Spanish, English, etc.).

In some embodiments of the LPM PLATFORM a Labor law notifications (or employment policy notification requirements) may be sent to the workforce through the LPM PLATFORM. In such embodiments employees may read (scroll) through the notification and confirm that they have read the notification by selecting yes or no and enter their pin number. If “yes” has been selected the employees photograph is taken and stored on file within the system. If “no” is selected a fault is produced which alerts the administrator that this employee needs help in understanding the notification. This feature may be proof that an organization has complied with the labor law notification requirements.

### LPM PLATFORM Controller

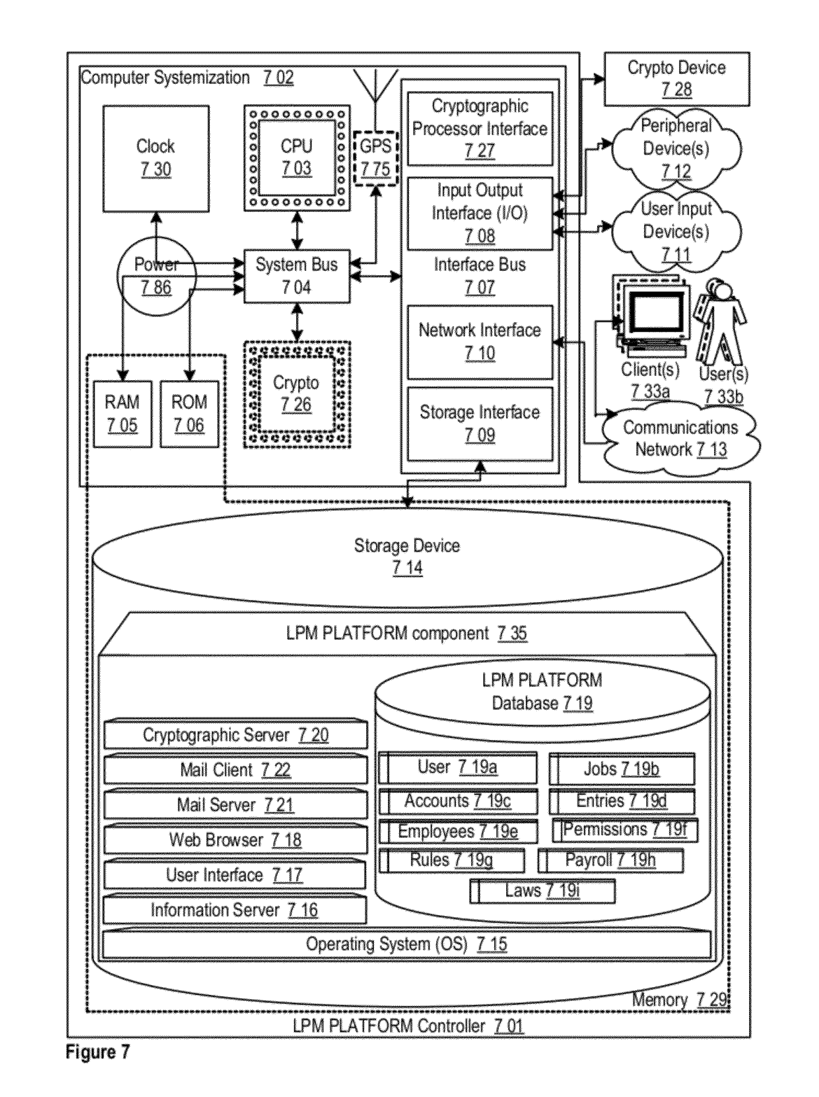

FIG. 7 illustrates inventive aspects of an LPM PLATFORM controller 701 in a block diagram. In this embodiment, the LPM PLATFORM controller 701 may serve to aggregate, process, store, search, serve, identify, instruct, generate, match, and/or facilitate interactions with a computer through various technologies, and/or other related data.

Typically, users, which may be people and/or other systems, may engage information technology systems (e.g., computers) to facilitate information processing. In turn, computers employ processors to process information; such processors 703 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 729 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the LPM PLATFORM controller 701 may be connected to and/or communicate with entities such as, but not limited to: one or more users from user input devices 711; peripheral devices 712; an optional cryptographic processor device 728; and/or a communications network 713.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The LPM PLATFORM controller 701 may be based on computer systems that may comprise, but are not limited to, components such as: a computer systemization 702 connected to memory 729.

### Computer Systemization computer systemization 702 may comprise a clock 730, central processing unit (“CPU(s)” and/or “processor(s)” (these terms are used interchangeable throughout the disclosure unless noted to the contrary)) 703, a memory 729 (e.g., a read only memory (ROM) 706, a random access memory (RAM) 705, etc.), and/or an interface bus 707, and most frequently, although not necessarily, are all interconnected and/or communicating through a system bus 704 on one or more (mother)board(s) 702 having conductive and/or otherwise transportive circuit pathways through which instructions (e.g., binary encoded signals) may travel to effectuate communications, operations, storage, etc. The computer systemization may be connected to a power source 786; e.g., optionally the power source may be internal. Optionally, a cryptographic processor 726 and/or transceivers (e.g., ICs) 774 may be connected to the system bus. In another embodiment, the cryptographic processor and/or transceivers may be connected as either internal and/or external peripheral devices 712 via the interface bus I/O. In turn, the transceivers may be connected to antenna(s) 775, thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing LPM PLATFORM controller to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 729 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the LPM PLATFORM controller and beyond through various interfaces. Should processing requirements dictate a greater amount speed and/or capacity, distributed processors (e.g., Distributed LPM PLATFORM), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the LPM PLATFORM may be achieved by implementing a microcontroller such as CAST's R8051XC2 microcontroller; Intel's MCS 51 (i.e., 8051 microcontroller); and/or the like. Also, to implement certain features of the LPM PLATFORM, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the LPM PLATFORM component collection (distributed or otherwise) and/or features may be implemented via the microprocessor and/or via embedded components; e.g., via ASIC, coprocessor, DSP, FPGA, and/or the like. Alternately, some implementations of the LPM PLATFORM may be implemented with embedded components that are configured and used to achieve a variety of features or signal processing.

Depending on the particular implementation, the embedded components may include software solutions, hardware solutions, and/or some combination of both hardware/software solutions. For example, LPM PLATFORM features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the LPM PLATFORM features. A hierarchy of programmable interconnects allow logic blocks to be interconnected as needed by the LPM PLATFORM system designer/administrator, somewhat like a one-chip programmable breadboard. An FPGA's logic blocks can be programmed to perform the operation of basic logic gates such as AND, and XOR, or more complex combinational operators such as decoders or mathematical operations. In most FPGAs, the logic blocks also include memory elements, which may be circuit flip-flops or more complete blocks of memory. In some circumstances, the LPM PLATFORM may be developed on regular FPGAs and then migrated into a fixed version that more resembles ASIC implementations. Alternate or coordinating implementations may migrate LPM PLATFORM controller features to a final ASIC instead of or in addition to FPGAs. Depending on the implementation all of the aforementioned embedded components and microprocessors may be considered the “CPU” and/or “processor” for the LPM PLATFORM.

### Power Source

The power source 786 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 786 is connected to at least one of the interconnected subsequent components of the LPM PLATFORM thereby providing an electric current to all subsequent components. In one example, the power source 786 is connected to the system bus component 704. In an alternative embodiment, an outside power source 786 is provided through a connection across the I/O 708 interface. For example, a USB and/or IEEE 1394 connection carries both data and power across the connection and is therefore a suitable source of power.

### Interface Adapters

Interface bus(ses) 707 may accept, connect, and/or communicate to a number of interface adapters, conventionally although not necessarily in the form of adapter cards, such as but not limited to: input output interfaces (I/O) 708, storage interfaces 709, network interfaces 710, and/or the like. Optionally, cryptographic processor interfaces 727 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 709 may accept, communicate, and/or connect to a number of storage devices such as, but not limited to: storage devices 714, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 710 may accept, communicate, and/or connect to a communications network 713. Through a communications network 713, the LPM PLATFORM controller is accessible through remote clients 733b (e.g., computers with web browsers) by users 733a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed LPM PLATFORM), architectures may similarly be employed to pool, load balance, and/or otherwise increase the communicative bandwidth required by the LPM PLATFORM controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 710 may be used to engage with various communications network types 713. For example, multiple network interfaces may be employed to allow for the communication over broadcast, multicast, and/or unicast networks.

Input Output interfaces (I/O) 708 may accept, communicate, and/or connect to user input devices 711, peripheral devices 712, cryptographic processor devices 728, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 711 often are a type of peripheral device 512 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 712 may be connected and/or communicate to I/O and/or other facilities of the like such as network interfaces, storage interfaces, directly to the interface bus, system bus, the CPU, and/or the like. Peripheral devices may be external, internal and/or part of the LPM PLATFORM controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 528), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the LPM PLATFORM controller may be embodied as an embedded, dedicated, and/or monitor-less (i.e., headless) device, wherein access would be provided over a network interface connection.

Cryptographic units such as, but not limited to, microcontrollers, processors 726, interfaces 727, and/or devices 728 may be attached, and/or communicate with the LPM PLATFORM controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: Broadcom's CryptoNetX and other Security Processors; nCipher's nShield; SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

### Memory

Generally, any mechanization and/or embodiment allowing a processor to affect the storage and/or retrieval of information is regarded as memory 729. However, memory is a fungible technology and resource, thus, any number of memory embodiments may be employed in lieu of or in concert with one another. It is to be understood that the LPM PLATFORM controller and/or a computer systemization may employ various forms of memory 729. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In a typical configuration, memory 729 will include ROM 706, RAM 705, and a storage device 714. A storage device 714 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 729 may contain a collection of program and/or database components and/or data such as, but not limited to: operating system component(s) 715 (operating system); information server component(s) 716 (information server); user interface component(s) 717 (user interface); Web browser component(s) 718 (Web browser); database(s) 719; mail server component(s) 721; mail client component(s) 722; cryptographic server component(s) 720 (cryptographic server); the LPM PLATFORM component(s) 735; and/or the like (i.e., collectively a component collection). These components may be stored and accessed from the storage devices and/or from storage devices accessible through an interface bus. Although non-conventional program components such as those in the component collection, typically, are stored in a local storage device 714, they may also be loaded and/or stored in memory such as: peripheral devices, RAM, remote storage facilities through a communications network, ROM, various forms of memory, and/or the like.

### Operating System

The operating system component 715 is an executable program component facilitating the operation of the LPM PLATFORM controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Nan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the LPM PLATFORM controller to communicate with other entities through a communications network 713. Various communication protocols may be used by the LPM PLATFORM controller as a subcarrier transport mechanism for interaction, such as, but not limited to: multicast, TCP/IP, UDP, unicast, and/or the like.

### Information Server

An information server component 716 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the LPM PLATFORM controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the LPM PLATFORM database 719, operating systems, other program components, user interfaces, Web browsers, and/or the like.

Access to the LPM PLATFORM database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the LPM PLATFORM. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the LPM PLATFORM as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 717 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 718 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the LPM PLATFORM enabled nodes. The combined application may be nugatory on systems employing standard Web browsers.

### Mail Server

A mail server component 721 is a stored program component that is executed by a CPU 703. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the LPM PLATFORM.

Access to the LPM PLATFORM mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 722 is a stored program component that is executed by a CPU 703. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 720 is a stored program component that is executed by a CPU 703, cryptographic processor 726, cryptographic processor interface 727, cryptographic processor device 728, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the LPM PLATFORM may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the LPM PLATFORM component to engage in secure transactions if so desired. The cryptographic component facilitates the secure accessing of resources on the LPM PLATFORM and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The LPM PLATFORM Database

The LPM PLATFORM database component 719 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the LPM PLATFORM database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the LPM PLATFORM database is implemented as a data-structure, the use of the LPM PLATFORM database 719 may be integrated into another component such as the LPM PLATFORM component 735. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 719 includes several tables 719a-g.

A Users table 719a includes fields such as, but not limited to: a user_id, user_accounts, user_name, user_email, user_PIN, user_PASS, user_phonenumber, user_jobtitle, user_jobdesignation, emergency_contact1, emergency_contact2, emergency_contact3, emergency_contact1email, emergency_contact1phone, emergency_contact2email, emergency_contact2phone and/or the like. The user table may support and/or track multiple entity accounts on a LPM PLATFORM.

A Jobs table 719b includes fields such as, but not limited to: user_id, user_PIN, user_password, job_id, job_location, job_route, job_code1, job_code2, job_SIC1, job_SIC2, worksite_id, worksite_info, worksite_location, and/or the like.

An Accounts table 719c includes fields such as, but not limited to: user_id, account_id, account_info, account_profile, account_value, PIN, password, security_question, security_answer, account_status, account_description, account_notes, and/or the like.

A Entries table 719d includes fields such as, but not limited to: entry_id, entry_info, entry_field, entry_value, entry_description, entry_location, entry_permission, and/or the like.

A Employees table 719e includes fields such as, but not limited to: employee_id, employee_account, employee_userid, employee_info, employee_PIN, employee_PASS, employee_phonenumber, employee_jobtitle, employee_jobdesignation, employee_contacts, employee_contact2, employee_contact3, employee_contact1email, employee_contact1phone, employee_contact2email, employee_contact2phone, employee_assignment, employee_billable, employee_faultactivity, and/or the like.

A Permissions table 719f includes fields such as, but not limited to: permission_id, permission_user, permission_employee, permission_account permission_info, permission_penalty, permission_value, permission_description, permission_association1, permission_association, and/or the like.

A Rules table 719g includes fields such as, but not limited to: rule_id, rule_info, rule_penalty, rule_value, rule_description, and/or the like.

A Payroll table 719h includes fields such as, but not limited to: user_id, user_PIN, user_password, payroll_id, payroll_code, payroll_date, payroll_deadline, payroll_amount, and/or the like.

A Laws table 719i includes fields such as, but not limited to: law_id, law_title, law_type, law_requirment1, law_requirement2, job_id, job_type, and/or the like.

In one embodiment, the LPM PLATFORM database may interact with other database systems. For example, employing a distributed database system, queries and data access by search LPM PLATFORM component may treat the combination of the LPM PLATFORM database, an integrated data security layer database as a single database entity.

In one embodiment, user programs may contain various user interface primitives, which may serve to update the LPM PLATFORM. Also, various accounts may require custom database tables depending upon the environments and the types of clients the LPM PLATFORM may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 719a-419i The LPM PLATFORM may be configured to keep track of various settings, inputs, and parameters via database controllers.

The LPM PLATFORM database may communicate to and/or with other components in a component collection, including itself, and/or facilities of the like. Most frequently, the LPM PLATFORM database communicates with the LPM PLATFORM component, other program components, and/or the like. The database may contain, retain, and provide information regarding other nodes and data.

### The LPM PLATFORMS

The LPM PLATFORM component 735 is a stored program component that is executed by a CPU. In one embodiment, the LPM PLATFORM component incorporates any and/or all combinations of the aspects of the LPM PLATFORM that was discussed in the previous figures. As such, the LPM PLATFORM affects accessing, obtaining and the provision of information, services, transactions, and/or the like across various communications networks.

The LPM PLATFORM transforms inputs (e.g., labor information, location information, activity data, login data, entry information, etc.) via LPM PLATFORM components (e.g., entry aggregator, labor monitoring component, fault tracking component, etc.) into outputs (e.g., user history reports, employee reports, entry reports, activity models, labor resource schemas, etc.).

The LPM PLATFORM component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the LPM PLATFORM server employs a cryptographic server to encrypt and decrypt communications. The LPM PLATFORM component may communicate to and/or with other components in a component collection, including itself, and/or facilities of the like. Most frequently, the LPM PLATFORM component communicates with the LPM PLATFORM database, operating systems, other program components, and/or the like. The LPM PLATFORM may contain, communicate, generate, obtain, and/or provide program component, system, user, and/or data communications, requests, and/or responses.

### Distributed LPM PLATFORMS

The structure and/or operation of any of the LPM PLATFORM node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the LPM PLATFORM controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the LPM PLATFORM controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

```
<?PHP
header(‘Content-Type: text/plain’);
// set ip address and port to listen to for incoming data
$address = ‘192.168.0.100’;
$port = 255;
// create a server-side SSL socket, listen for/accept incoming
communication
$sock = socket_create(AF_INET, SOCK_STREAM, 0);
socket_bind($sock, $address, $port) or die(‘Could not bind to address’);
socket_listen($sock);
$client = socket_accept($sock);
// read input data from client device in 1024 byte blocks until end of
message
do {
    $input = “”;
    $input = socket_read($client, 1024);
    $data .= $input;
} while($input != “”);
// parse data to extract variables
$obj = json_decode($data, true);
// store input data in a database
mysql_connect(“201.408.185.132”,$DBserver,$password); // access
database server
mysql_select(“CLIENT_DB.SQL”); // select database to append
mysql_query(“INSERT INTO UserTable (transmission)
VALUES ($data)”); // add data to UserTable table in a CLIENT database
mysql_close(“CLIENT_DB.SQL”); // close connection to database
?>
```

Also, the following resources may be used to provide example embodiments regarding SOAP parser implementation:

http://www.xav.com/perl/site/lib/SOAP/Parser.html
http://publib.boulder.ibm.com/infocenter/tivihelp/v2r1/index.jsp?topic=
/com.ibm.IBMDI.doc/referenceguide295.htm

and other parser implementations:

http://publib.boulder.ibm.com/infocenter/tivihelp/v2r1/index.jsp?topic=
/com.ibm.IBMDI.doc/referenceguide259.htm

all of which are hereby expressly incorporated by reference.

In order to address various issues and advance the art, the entirety of this application for APPARATUSES, METHODS, AND SYSTEMS FOR A LABOR PROJECT MANAGEMENT AND COSTING SYSTEM AND PLATFORM (including the Cover Page, Title, Headings, Field, Background, Summary, Brief Description of the Drawings, Detailed Description, Claims, Abstract, Figures, Appendices, and otherwise) shows, by way of illustration, various embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations in part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a LPM PLATFORM individual and/or enterprise user, database configuration and/or relational model, data type, data transmission and/or network framework, syntax structure, and/or the like, various embodiments of the LPM PLATFORM, may be implemented that enable a great deal of flexibility and customization. For example, aspects of the LPM PLATFORM may be adapted for resource and event management. While various embodiments and discussions of the LPM PLATFORM have been directed to labor management, however, it is to be understood that the embodiments described herein may be readily configured and/or customized for a wide variety of other applications and/or implementations.

What is claimed is:

1. A labor management processor-implemented method to transform identification information into an activity entry, comprising:
receiving identification data;
determining job elements associated with the identification data;
responsive to the job elements, receiving activity data; and
generating an activity entry, according to the job elements, comprised of the activity data, the identification data, a time element, and a location element.

2. The method of claim 1, wherein the identification data further comprises a personal identification number.

3. The method of claim 1, wherein the identification data is associated with a user account history.

4. The method of claim 1, further comprising:
updating an activity profile associated with the identification data and the activity entry.

5. An activity entry processor-readable medium storing processor-issuable-instructions to:
receive identification data;
determine job elements associated with the identification data;
responsive to the determined job elements, receive activity data; and
generate an activity entry, according to the job elements, comprised of the activity data, the identification data, a time element, and a location element.

6. An activity entry apparatus, comprising:
a memory;
a processor disposed in communication with said memory, and configured to issue a plurality of processing instructions stored in the memory, wherein the processor issues instructions to:
receive identification data;
determine job elements associated with the identification data;
responsive to the determined job elements, receive activity data; and
generate an activity entry, according to the job elements, comprised of the activity data, the identification data, a time element, and a location element.

7. A labor management processor-implemented method to transform user login information to a labor activity entry, comprising:
receiving login information;
updating a login history element with the login information;
responsive to the updated login history element, receiving target job information;
determining job elements related to target job information;
responsive to the determined job elements, receiving a job selection;
receiving identification information associated with the job selection;
verifying identification information with the determined job elements;
receiving activity information; and
generating a labor activity entry based upon the activity information, identification information, the job elements, and an iterated login history element.

8. The method of claim 7, wherein the login information further comprises a time element and a location element.

9. The method of claim 7, further comprising:
determining fault activity information based on the labor activity entry, the identification data, and a historic labor activity entry.
